(19) United States
(12) Patent Application Publication
(10) Pub. No.: US 2015/0381048 A1
(43) Pub. Date: Dec. 31, 2015

(54) METHOD AND ELECTRONIC DEVICE FOR CONTROLLING SWITCHING REGULATOR

(71) Applicant: Samsung Electronics Co., Ltd., Gyeonggi-do (KR)

(72) Inventors: Dae Woong KIM, Gyeonggi-do (KR); Cheol Ho LEE, Gyeonggi-do (KR); Dong Ho YU, Gyeonggi-do (KR); Eun Seok HONG, Gyeonggi-do (KR)

(21) Appl. No.: 14/751,524

(22) Filed: Jun. 26, 2015

(30) Foreign Application Priority Data
Jun. 26, 2014 (KR) 10-2014-0078862

(51) Int. Cl. H02M 3/158

(52) U.S. Cl. CPC H02M 3/158

(57) ABSTRACT

An electronic device includes: a first switching regulator configured to output a predetermined voltage to a first unit of an electronic device through on/off switching corresponding to a control signal received from a switching control unit; a second switching regulator configured to output a predetermined voltage to a second unit of the electronic device through on/off switching corresponding to a control signal received from the switching control unit; and a switching control unit configured to determine an off timing of each switching regulator corresponding to an on/off duty ratio of the each switching regulator and control on/off of the each switching regulator in order to turn on the second switching regulator at an off timing of the first switching regulator.

### CLAIM OF PRIORITY

This application claims the benefit under 35 U.S.C. §119(a) of a Korean patent application filed on Jun. 26, 2014 in the Korean Intellectual Property Office and assigned Serial number 10-2014-0078862, the entire disclosure of which is hereby incorporated by reference.

### TECHNICAL FIELD

The present disclosure relates to a method and electronic device for controlling a switching regulator.

### BACKGROUND

A power management module of an electronic device may supply a predetermined voltage to each unit thereof by converting a voltage supplied from a power supply unit. Since an operating voltage of each unit of an electronic device varies, a power management module may output a unit specific voltage corresponding to the operating voltage of the each unit by using at least one DC-DC converter.

### SUMMARY

Accordingly, an aspect of the present disclosure is to provide a method and electronic device for controlling a switching regulator.

Another aspect of the present disclosure is to provide a computer readable recording medium having a program thereon, which, when executed by a computer, implements the method for controlling a switching diagram.

In accordance with an aspect of the present disclosure, an electronic device includes: a first switching regulator configured to output a predetermined voltage to a first unit of an electronic device through on/off switching corresponding to a control signal received from a switching control unit; a second switching regulator configured to output a predetermined voltage to a second unit of the electronic device through on/off switching corresponding to a control signal received from the switching control unit; and a switching control unit configured to determine an off timing of each switching regulator corresponding to an on/off duty ratio of the each switching regulator and control on/off of the each switching regulator in order to turn on the second switching regulator at an off timing of the first switching regulator.

In accordance with another aspect of the present disclosure, provided is a method of controlling a switching regulator. The method includes: turning on a first switching regulator outputting a predetermined voltage of a first unit of an electronic device through on/off switching; turning on a second switching regulator outputting a predetermined voltage to a second unit of the electronic device through on/off switching simultaneously when turning off the first switching regulator at an off timing of the first switching regulator determined based on an on/off duty ratio of the first switching regulator; and turning off the second switching regulator at an off timing of the second switching regulator determined based on an on/off duty ratio of the second switching regulator.

### BRIEF DESCRIPTION OF THE DRAWINGS

FIG. 1 is a graph illustrating switching noise occurring from a switching regulator.

FIG. 2 is a graph illustrating an input current measured by an electronic device to which an existing method for controlling a switching regulator is applied.

FIG. 3 is a graph illustrating an input current measured by an electronic device to which an existing method for controlling a switching regulator is applied.

FIG. 4 is a block diagram illustrating an electronic device according to various embodiments of the present disclosure.

FIG. 5 is a block diagram illustrating a power management module of an electronic device according to various embodiments of the present disclosure.

FIG. 6 is a graph illustrating an input current measured by an electronic device to which a switching regulator controlling method is applied according to various embodiments of the present disclosure.

FIG. 7 is a flowchart illustrating a method of controlling a switching regulator in an electronic device according to various embodiments of the present disclosure.

FIG. 8 is a block diagram of an electronic device according to various embodiments of the present disclosure.

### DETAILED DESCRIPTION

Hereinafter, various embodiments of the present disclosure are disclosed with reference to the accompanying drawings. Various modifications are possible in various embodiments of the present disclosure and specific embodiments are illustrated in drawings and related detailed descriptions are listed. However, this does not limit various embodiments of the present disclosure to a specific embodiment and it should be understood that the present disclosure covers all the modifications, equivalents, and/or replacements of this disclosure provided they come within the scope of the appended claims and their equivalents. With respect to the descriptions of the drawings, like reference numerals refer to like elements.

The term “include,” “comprise,” and “have”, or “may include,” or “may comprise” and “may have” used herein indicates disclosed functions, operations, or existence of elements but does not exclude other functions, operations or elements. Additionally, in various embodiments of the present disclosure, the term “include,” “comprise,” “including,” or “comprising,” specifies a property, a region, a fixed number, a step, a process, an element and/or a component but does not exclude other properties, regions, fixed numbers, steps, processes, elements and/or components.

In various embodiments of the present disclosure, expression “A or B” or “at least one of A or/and B” may include all possible combinations of items listed together. For instance, the expression “A or B”, or “at least one of A or/and B” may indicate include A, B, or both A and B.

The terms such as “1st”, “2nd”, “first”, “second”, and the like used herein may refer to modifying various different elements of various embodiments of the present disclosure, but do not limit the elements. For instance, such expressions do not limit the order and/or importance of corresponding components. The expressions may be used to distinguish one element from another element. For instance, both “a first user device” and “a second user device” indicate a user device but indicate different user devices from each other. For example, a first component may be referred to as a second component and vice versa without departing from the scope of the present disclosure.

In this disclosure below, when one part (or element, device, etc.) is referred to as being “connected” to another part (or element, device, etc.), it should be understood that the former can be “directly connected” to the latter, or “connected” to the latter via an intervening part (or element, device, etc.). In contrast, when an element is referred to as being “directly connected” or “directly coupled” to another element, there are no intervening elements present.

In various embodiments of the present disclosure, terms used in this specification are used to describe specific embodiments, and are not intended to limit the scope of the present disclosure. The terms of a singular form may include plural forms unless they have a clearly different meaning in the context. Otherwise indicated herein, all the terms used herein, which include technical or scientific terms, may have the same meaning that is generally understood by a person skilled in the art. In general, the terms defined in the dictionary should be considered to have the same meaning as the contextual meaning of the related art, and, unless clearly defined herein, should not be understood abnormally or as having an excessively formal meaning.

Additionally, an electronic device according to various embodiments of the present disclosure may be a device with a camera function. For instance, electronic devices may include at least one of smartphones, tablet personal computers (PCs), mobile phones, video phones, electronic book (e-book) readers, desktop personal computers (PCs), laptop personal computers (PCs), netbook computers, personal digital assistants (PDAs), portable multimedia player (PMPs), MP3 players, mobile medical devices, cameras, and wearable devices (for example, head-mounted-devices (HMDs) such as electronic glasses, electronic apparel, electronic bracelets, electronic necklaces, electronic appcessories, electronic tattoos, and smart watches).

According to some embodiments of the present disclosure, an electronic device may be smart home appliances having a data storing function. The smart home appliances may include at least one of, for example, televisions, digital video disk (DVD) players, audios, refrigerators, air conditioners, cleaners, ovens, microwave ovens, washing machines, air cleaners, set-top boxes, TV boxes (for example, Samsung HomeSync™, Apple TV™ or Google TV™), game consoles, electronic dictionaries, electronic keys, camcorders, and electronic picture frames.

According to some embodiments of the present disclosure, an electronic device may include at least one of various medical devices (for example, magnetic resonance angiography (MRA) devices, magnetic resonance imaging (MRI) devices, computed tomography (CT) devices, medical imaging devices, ultrasonic devices, etc.), navigation devices, global positioning system (GPS) receivers, event data recorders (EDRs), flight data recorders (FDRs), vehicle infotainment devices, marine electronic equipment (for example, marine navigation systems, gyro compasses, etc.), avionics, security equipment, vehicle head modules, industrial or household robots, financial institutions' automatic teller machines (ATMs), and stores' point of sales (POS).

In various embodiments of the present disclosure, an electronic device may include at least one of part of furniture or buildings/structures supporting call forwarding service, electronic boards, electronic signature receiving devices, projectors, and various measuring instruments (for example, water, electricity, gas, or radio signal measuring instruments), each of which has a screen display function. An electronic device according to various embodiments of the present disclosure may be one of the above-mentioned various devices or a combination thereof. Additionally, an electronic device according to various embodiments of the present disclosure may be a flexible device. Furthermore, it is apparent to those skilled in the art that an electronic device according to various embodiments of the present disclosure is not limited to the above-mentioned devices.

Hereinafter, an electronic device according to various embodiments of the present disclosure will be described in more detail with reference to the accompanying drawings. The term “user” in various embodiments may refer to a person using an electronic device or a device using an electronic device (for example, an artificial intelligent electronic device).

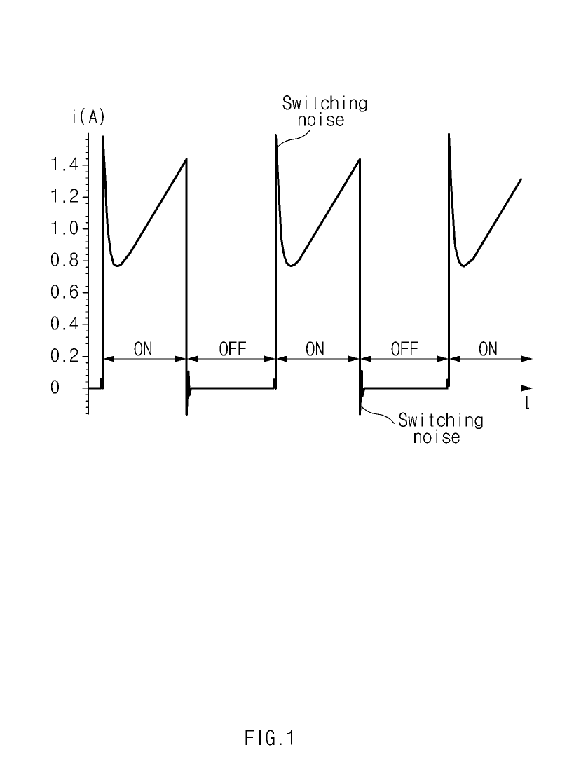

FIG. 1 is a graph illustrating switching noise occurring from a switching regulator. Referring to FIG. 1, accordingly, it is observed that switching noise occurs at the falling timing that a switching regulator switches from on to off. Additionally, it is observed that switching noise occurs at the rising timing that the switching regulator switches from off to on. In such a manner, switching noise of high frequency may occur by on/off switching of the switching regulator.

Due to the increase of switching frequency and the increase of current consumption of a power management module, switching noise of high frequency occurring by a switching regulator included in the power management module is increased. Switching noise of high frequency occurring due to a plurality of switching regulators included in an electronic device may flow into signals or powers and due to this, the performance and stability of an electronic device may be deteriorated.

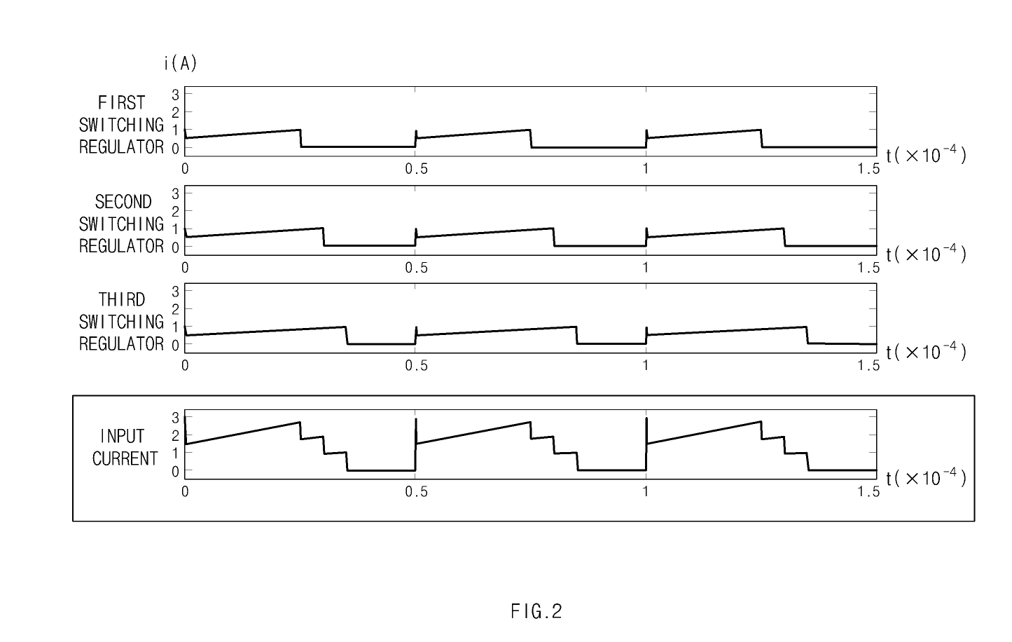

FIG. 2 is a graph illustrating an input current measured by an electronic device to which an existing method for controlling a switching regulator is applied. A case that an electronic device includes three switching regulators is described as an example. As shown in FIG. 2, when three switching regulators operate at the same timing, input current is increased. As input current is increased, it is confirmed that switching noise is increased.

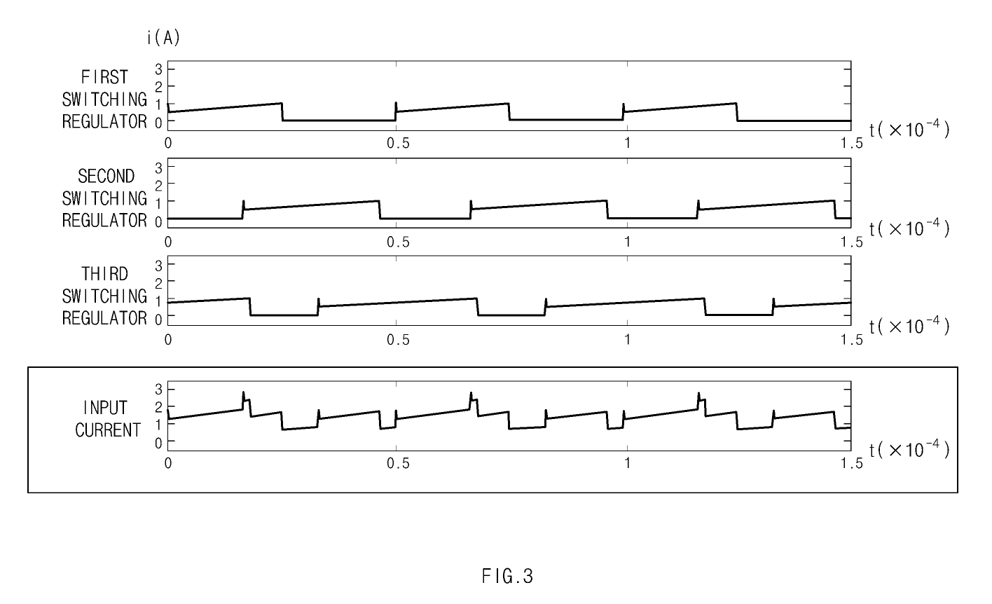

FIG. 3 is a graph illustrating an input current measured by an electronic device to which an existing method for controlling a switching regulator is applied. A case that an electronic device includes three switching regulators is described as an example. In order to prevent the occurrence of excessive switching noise, the method of FIG. 3 controls a switching regulator by evenly dividing the operating timings of a plurality of switching regulators in order for preventing each switching regulator from operating at the same timing. As shown in FIG. 3, since each switching regulator operates at the evenly divided timing, in comparison to FIG. 2, it is observed that a change amount in input current is reduced. However, a change amount in input current is still large and switching noise due to a change amount in input current is excessive.

Accordingly, in order to secure high performance and stability in an electronic device, measures to minimize switching noise occurring from a switching regulator are required.

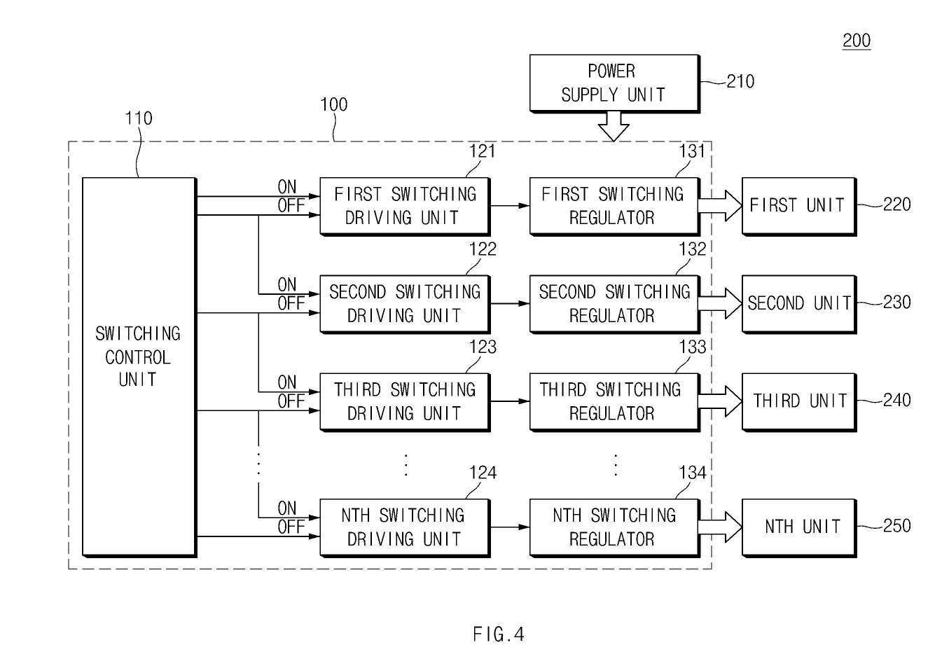

FIG. 4 is a block diagram illustrating an electronic device according to various embodiments of the present disclosure.

Referring to FIG. 4, an electronic device 200 may include a power management module 100, a power supply unit 210, a first unit 220, a second unit 230, a third unit 240, and an Nth unit 250. The power management module 100 may include a switching control unit 110, a first switching driving unit, a third switching driving unit 123, an Nth switching driving unit 124, a first switching regulator 131, a second switching regulator 132, a third switching regulator 133, and an Nth switching regulator 134 (N is a natural number of two or more).

Although only the first switching regulator 131, the second switching regulator 132, the third switching regulator 133, and the Nth switching regulator 134 are shown in FIG. 4 for convenience of description, an electronic device according to various embodiments of the present disclosure may include only two switching regulators, for example, the first switching regulator 131 and the second switching regulator 132.

In this specification, only components relating to various embodiments of the present disclosure are described in order not to obscure the features of the present disclosure. Accordingly, it is apparent to those skilled in the art that general components other than the components shown in FIG. 4 may be further included.

The power management module 100 may supply a unit specific voltage to the first unit 220 to the Nth unit 250 of the electronic device 200. For example, the power management module 100 may supply a predetermined voltage to the first unit 220 to the Nth unit 250 of the electronic device 200 by converting a voltage supplied from the power supply unit 210.

Since an operating voltage of each unit of the electronic device 200 varies, the power management module 100 may output a unit specific voltage according to operating voltages of the first unit 220 to the Nth unit 250 of the electronic device 200 by using at least one regulator. For example, the power management module 250 may supply voltages corresponding to operating voltages of the first unit 220 to the Nth unit 250 of the electronic device 200 by stepping down a voltage supplied through the power supply unit 210 as using at least one regulator.

The power management module 100 may include at least one regulator in order to output a unit specific voltage to the first unit 220 to the Nth unit 250 of the electronic device 200. According to various embodiments of the present disclosure, the power management module 100 may include a switching regulator such as a buck converter, a boost converter, and a buck-boost converter, a low dropout (LDO) regulator, and an un regulated DC/DC converter.

Hereinafter, in order to make features relating to various embodiments of the present disclosure clear, it is described that the power management module 100 outputs unit specific voltages to the first unit 220 to the Nth unit 250 by using the first switching regulator 131 to the Nth switching regulator 134. However, the present disclosure is not limited thereto and the power management module may further include another regulator such as an LDO regulator or an unregulated DC/DC converter in addition to a switching regulator.

The switching control unit 110 may control on/off of the first switching regulator 131 to the Nth switching regulator 134. The switching control unit 110 may output control signals to the first switching regulator 131 to the Nth switching regulator 134, thereby controlling on/off switching of the first switching regulator 131 to the Nth switching regulator.

The switching control unit 110 may determine the off timings of the first switching regulator 131 to the Nth switching regulator 134 according to an on/off duty ratio of the first switching regulator 131 to the Nth switching regulator. The on/off duty ratio of the first switching regulator 131 to the Nth switching regulator 134 may be determined based on an input voltage and an output voltage of a corresponding switching regulator.

According to an embodiment of the present disclosure, the switching control unit 110 may receive a feedback of an output voltage of the each switching regulator and may adjust the on/off duty ratio on the basis of a change in the output voltage according to load current.

According to an embodiment of the present disclosure, the switching control unit 110 may control on/off of the first switching regulator 131 and the second switching regulator 132 in order to allow the second switching regulator 132 to be turned on at the off timing of the first switching regulator 131. The falling timing of the first switching regulator 131 at which the first switching regulator 131 switches from on to off may correspond to the rising timing of the second switching regulator 132 at which the second switching regulator 132 switches from off to on. Accordingly, switching noise occurring at the falling timing of the first switching regulator 131 and switching noise occurring at the rising timing of the second switching regulator 132 may be cancelled out each other. For example, the switching control unit 110 may input a control signal for turning off the first switching regulator 131 to the second switching regulator 132, thereby turning on the second switching regulator 132.

When the power management module 100 further includes the third switching regulator 133, the switching control unit 110 may control on/off of the second switching regulator 132 and the third switching regulator 133 in order to allow the third switching regulator 133 to be turned on at the off timing of the second switching regulator 132. The falling timing of the second switching regulator 132 at which the second switching regulator 132 switches from on to off may correspond to the rising timing of the third switching regulator 133 at which the third switching regulator 133 switches from off to on. Accordingly, switching noise occurring at the falling timing of the second switching regulator 132 and switching noise occurring at the rising timing of the third switching regulator 133 may be cancelled out each other.

Similarly, the switching control unit 110 may control on/off of each of a plurality of switching regulator in order to allow the Nth switching regulator 134 to be turned on at the off timing of the N−1th switching regulator. The switching control unit 110 may determine the off timing of the N−1th switching regulator as the on timing of the Nth switching regulator 134. The switching control unit 110 may determine the off timing of the Nth switching regulator 134 according to an on/off duty ratio of the Nth switching regulator 134. The falling timing of the N−1th switching regulator at which the N−1th switching regulator switches from on to off may correspond to the rising timing of the Nth switching regulator 132 at which the Nth switching regulator 134 switches from off to on. Accordingly, switching noise occurring at the falling timing of the N−1th switching regulator and switching noise occurring at the rising timing of the Nth switching regulator 134 may be cancelled out each other. Overall, high frequency switching noise occurring from the electronic device 200 is reduced so that the performance and stability of the electronic device 200 may be improved.

According to an embodiment of the present disclosure, the switching control unit 110 may become a pulse width modulation (PWM) IC for controlling the pulse width of an output waveform by turning on/off the first switching regulator 131 to the Nth switching regulator 134.

Referring to FIG. 4, the first switching driving unit 121 to the Nth switching driving unit 124 are shown as units separated from the first switching regulator 131 to the Nth switching regulator 134. However, the present disclosure is not limited thereto, and according to various embodiments of the present disclosure, the first switching driving unit 121 to the Nth switching driving unit 124 may be respectively included in the first switching regulator 131 to the Nth switching regulator 134.

The first switching driving unit 121 to the Nth switching driving unit 124 may respectively correspond to the first switching regulator 131 to the Nth switching regulator 134. The first switching driving unit 121 to the Nth switching driving unit 124 may respectively drive the first switching regulator 131 to the Nth switching regulator 134.

According to an embodiment of the present disclosure, each switching regulator may include two switches. On/off of each switching regulator may be determined by on/off of two switches. Accordingly, the first switching driving unit 121 to the Nth switching driving unit 124 may allow the each switching regulator to be turned on/off by driving a switch included in each of the first switching regulator 131 to the Nth switching regulator 134.

According to an embodiment of the present disclosure, each of the first switching regulator 131 to the Nth switching regulator 134 may include two MOSFET switches and the switching driving unit may become a gate driver fro driving a MOSFET switch included in each switching regulator but the present disclosure is not limited thereto.

The first switching regulator 131 to the Nth switching regulator 134 are switched to on/off according to a control signal received from the switching control unit 110.

For example, the second switching regulator 132 may be turned on at the off timing of the first switching regulator 131. The third switching regulator 133 may be turned on at the off timing of the second switching regulator 132. Similarly, the switching control unit 110 may turn on the Nth switching regulator 134 at the off timing of the N−1th switching regulator. Accordingly, the falling timing of the first switching regulator 131 may correspond to the rising timing of the second switching regulator 132, the falling timing of the second switching regulator may correspond to the rising timing of the third switching regulator, and the falling timing of the N−1th switching regulator may correspond to the rising timing of the fourth switching regulator 134.

The first switching regulator 131 to the Nth switching regulator 134 may output a predetermined voltage to each unit of the electronic device 200 through on/off switching according to the control signal.

For example, the first switching regulator 131 may output a predetermined voltage to the first unit 220 of the electronic device 200 through on/off switching according to a control signal received from the switching control unit 110. The second switching regulator 132 may output a predetermined voltage to the second unit 230 of the electronic device 200 through on/off switching according to a control signal received from the switching control unit 110. Similarly, the Nth switching regulator 134 may output a predetermined voltage to the Nth unit 250 of the electronic device 200 through on/off switching according to a control signal received from the switching control unit 110.

According to various embodiments of the present disclosure, the first switching regulator 131 to the Nth switching regulator 134 may have the same switching frequency.

According to various embodiments of the present disclosure, the each switching regulator may be at least one of a buck converter, a boost converter, and a buck-boost converter.

The power supply unit 210 may supply power to the power management module 110. For example, the power supply unit 210 may supply power to the power management module 100 by converting a voltage supplied from a battery (not shown).

The first unit 220, the second unit 230, the third unit 240, and the Nth unit 250 may operate by using voltages outputted from the first switching regulator 131 to the Nth switching regulator 134. According to various embodiments of the present disclosure, the first unit 220, the second unit 230, the third unit 240, and the Nth unit 250 may become a module, a unit, an IC, a device, and an element for performing various functions of the electronic device 200.

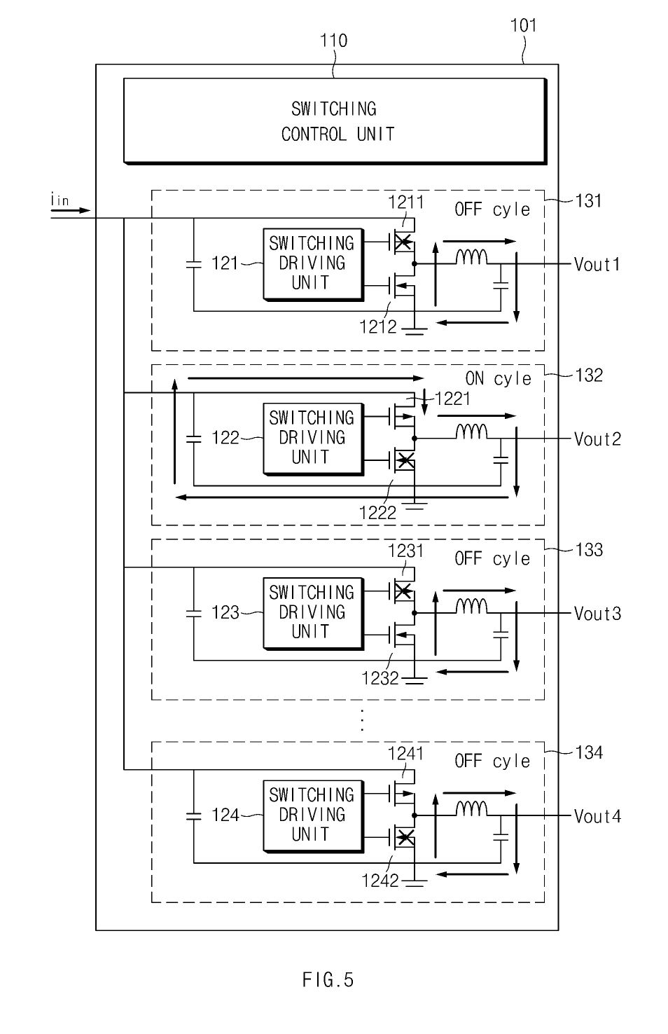

FIG. 5 is a block diagram illustrating a power management module 101 of an electronic device according to various embodiments of the present disclosure.

According to an embodiment of the present disclosure, as shown in FIG. 5, each of a first switching regulator 131 to an Nth switching regulator 134 may include two switches to be turned on/off and a switching driving unit for driving the two switches. For example, the two switches may be MOSFET but is not limited thereto.

For convenience of description, the first switching regulator 131 to the Nth switching regulator 134 are shown as buck converters in this embodiment. However, according to various embodiments of the present disclosure, the each switching regulator may be at least one of a buck converter, a boost converter, and a buck-boost converter.

The two switches included in each of the first switching driving unit 131 to the Nth switching driving unit 134 may be respectively turned on/off by a first switching driving unit 121 to an Nth switching driving unit 124. Each switching regulator may be turned on/off by on/off of the two switches included in each of the first switching driving unit 131 to the Nth switching driving unit 134.

For example, the first switching driving unit 121 may turn on/off the two switches 1211 and 1212 included in the first switching regulator 131 by receiving a control signal from the switching control unit 110. Similarly, the Nth switching driving unit 124 may turn on/off the two switches 1241 and 1242 included in the Nth switching regulator 134 by receiving a control signal from the switching control unit 110. Accordingly, the each switching regulator may be turned on/off.

For example, as shown in FIG. 5, the first switch 1211 may be in an off state and the second switch 1212 may be in an on state by the switching driving unit 121 in the first switching regulator 131. Accordingly, the first switching regulator 131 may be in an off state. Alternatively, it is also said that the first switching regulator 131 may be in an off cycle.

The switching control unit 110 may turn on the second switching regulator 132 at the off timing of the first switching regulator 131 by transmitting a control signal to the first switching driving unit 121 and the second switching driving unit 122.

Accordingly, the first switch 1221 may be in an on state and the second switch 1222 may be in an off state by the switching driving unit 122 in the second switching regulator 132. Accordingly, the second switching regulator 132 may be in an on state. Alternatively, it is also said that the second switching regulator 132 may be in an on cycle.

The switching control unit 110 may determine the off timing of the second switching regulator 132 according to an on/off duty cycle of the second switching regulator 132. The switching driving unit 122, which receives a control signal from the switching control unit 110, may turn off the first switch 1221 and turn on the second switch 1222 in order to turn off the second switching regulator 132 according to the off timing.

The switching control unit 110 may turn on the third switching regulator 133 at the off timing of the second switching regulator 132 by transmitting a control signal to the second switching driving unit 122 and the third switching driving unit 123. Similarly, the switching control unit 110 may turn on the Nth switching regulator 134 at the off timing of the N−1th switching regulator.

According to various embodiments of the present disclosure, the first switching regulator 131 to the Nth switching regulator 134 may have the same switching frequency.

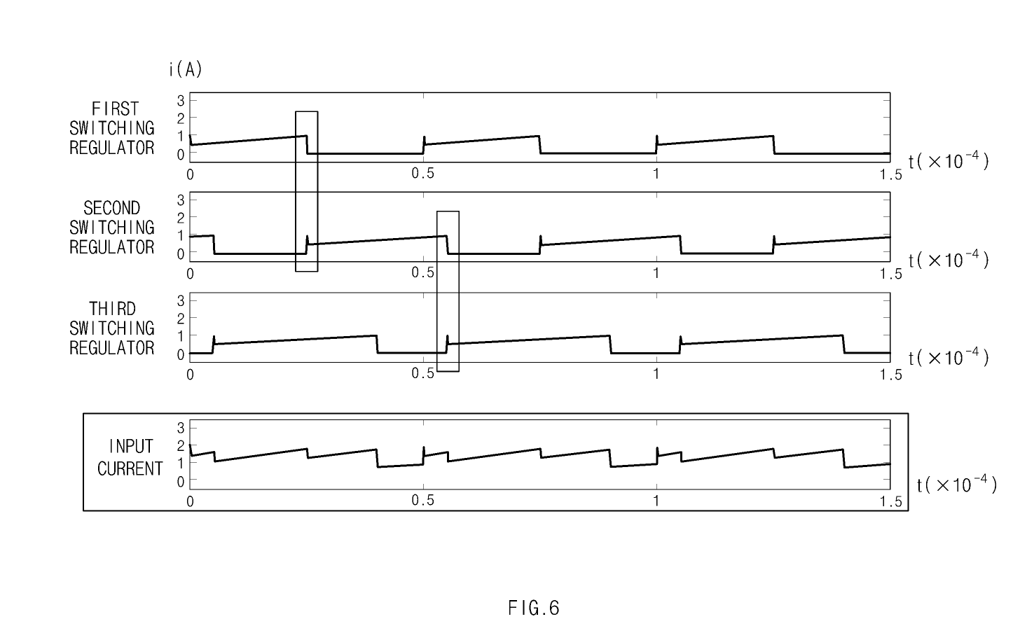

FIG. 6 is a graph illustrating an input current measured by an electronic device according to various embodiments of the present disclosure.

For convenience of description, this embodiment shows three switching regulators, for example, a first switching regulator to a third switching regulator. However, as described above, the electronic device 200 according to this embodiment of the present disclosure may include two switching regulators or three or more switching regulators.

Referring to FIG. 6, the second switching regulator 132 may be switched from off to on at the falling timing of the first switching regulator 131 at which the first switching regulator 131 switches from on to off. That is, it is seen that the falling timing of the first switching regulator 131 corresponds to the rising timing of the second switching regulator 132. Accordingly, switching noise occurring at the falling timing of the first switching regulator 131 and switching noise occurring at the rising timing of the second switching regulator 132 may be cancelled out each other.

Additionally, the third switching regulator 133 may be switched from off to on at the falling timing of the second switching regulator 132 at which the second switching regulator 132 switches from on to off. That is, it is seen that the falling timing of the second switching regulator 132 corresponds to the rising timing of the third switching regulator 133. Accordingly, switching noise occurring at the falling timing of the second switching regulator 132 and switching noise occurring at the rising timing of the third switching regulator 133 may be cancelled out each other.

Accordingly, high frequency switching noise occurring from the electronic device 200 is reduced so that the performance and stability of the electronic device 200 may be improved.

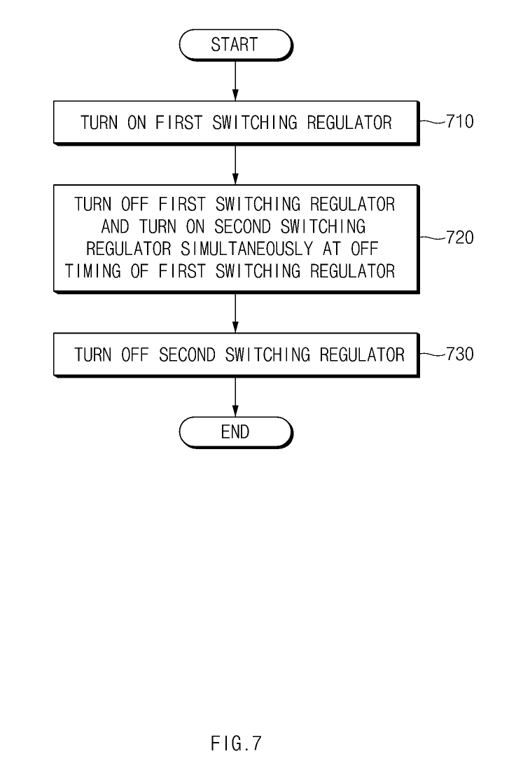

FIG. 7 is a flowchart illustrating a method of controlling a switching regulator in an electronic device according to various embodiments of the present disclosure.

Referring to FIG. 7, the method shown in FIG. 7 is configured with operations processed in the electronic device 200 shown in FIG. 4. Accordingly, although some content is omitted from this embodiment of the present disclosure, the above described content relating to the electronic device 200 of FIG. 4 is applied to the method shown in FIG. 7.

For convenience of description, the method shown in FIG. 7 is described using two switching regulators such as a first switching regulator and a second switching regulator. However, as described above, the method shown in FIG. 7 may be applied to the electronic device 200 including two or more switching regulators.

In operation 710, the electronic device 200 may turn on the first switching regulator 131. The first switching regulator 131 may output a predetermined voltage to the first unit 220 of the electronic device 200 through on/off switching.

In operation 720, the electronic device 200 may turn off the first switching regulator 131 and turn on the second switching regulator 132 simultaneously at the off timing of the first switching regulator 131. The second switching regulator 132 may output a predetermined voltage to the second unit 230 of the electronic device 200 through on/off switching. The off timing of the first switching regulator 131 may be determined on the basis of an on/off duty ratio of the first switching regulator 131.

In operation 730, the electronic device 200 may turn off the second switching regulator 132 at the off timing of the second switching regulator 132. The off timing of the second switching regulator 132 may be determined on the basis of an on/off duty ratio of the second switching regulator 132.

As mentioned above, the electronic device 200 may turn off the Nth switching regulator 134 at the off timing of the N−1th switching regulator. The off timing of the Nth switching regulator 134 may be determined on the basis of an on/off duty ratio of the Nth switching regulator 134.

According to various embodiments of the present disclosure, the first switching regulator 131 may have the same switching frequency as the second switching regulator 132.

According to various embodiments of the present disclosure, the electronic device 200 may include receiving a feedback of an output voltage of each of the first switching regulator 131 and the second switching regulator 132 and adjusting an on/off duty ratio of the first switching regulator 131 or the second switching regulator 132 on the basis of a change in the output voltage according to load current.

According to various embodiments of the present disclosure, the on/off duty ratio of the first switching regulator 131 or the second switching regulator 132 may be determined based on an input voltage and an output voltage of a corresponding switching regulator.

According to various embodiments of the present disclosure, the first switching regulator 131 or the second switching regulator 132 may be at least one of a buck converter, a boost converter, and a buck-boost converter.

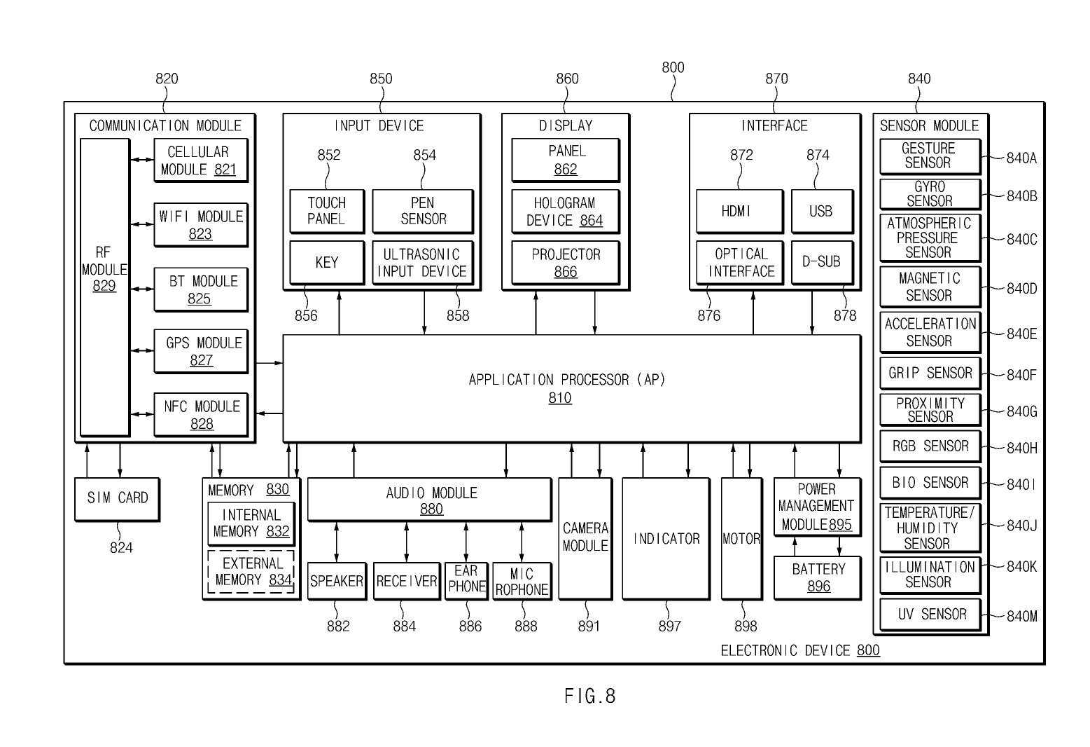

FIG. 8 is a block diagram illustrating an electronic device according to various embodiments of the present disclosure.

Referring to FIG. 10, the electronic device 801 may include application processor (AP) 810, a communication module 820, a subscriber identification module (SIM) card 824, a memory 830, a sensor module 840, an input device 850, a display 860, an interface 870, an audio module 880, a camera module 891, a power management module 895, a battery 896, an indicator 897, and a motor 898.

The AP 810 may control a plurality of hardware or software components connected to the AP 810 and also may perform various data processing and operations with multimedia data by executing an operating system or an application program. The AP 810 may be implemented with a system on chip (SoC), for example. According to an embodiment of the present disclosure, the AP 810 may further include a graphic processing unit (GPU) (not shown).

The communication module 820 may perform data transmission/reception between the electronic device 800 and other electronic devices connected via network. According to an embodiment of the present disclosure, the communication module 820 may include a cellular module 821, a WiFi module 823, a BT module 825, a GPS module 827, an NFC module 828, and a radio frequency (RF) module 829.

The cellular module 821 may provide voice calls, video calls, text services, or internet services through a communication network (for example, LTE, LTE-A, CDMA, WCDMA, UMTS, WiBro, or GSM). Additionally, the cellular module 821 may perform a distinction and authentication operation on an electronic device in a communication network by using a subscriber identification module (for example, the SIM card 824), for example. According to an embodiment of the present disclosure, the cellular module 821 may perform at least part of a function that the AP 810 provides. For example, the cellular module 821 may perform at least part of a multimedia control function.

According to an embodiment of the present disclosure, the cellular module 821 may further include a communication processor (CP). Additionally, the cellular module 821 may be implemented with SoC, for example. As shown in FIG. 8, components such as the cellular module 821 (for example, a CP), the memory 830, or the power management module 895 are separated from the AP 810, but according to an embodiment of the present disclosure, the AP 810 may be implemented including some of the above-mentioned components (for example, the cellular module 821).

According to an embodiment of the present disclosure, the AP 810 or the cellular module 821 (for example, a CP) may load instructions or data, which are received from a nonvolatile memory or at least one of other components connected thereto, into a volatile memory and then may process them. Furthermore, the AP 810 or the cellular module 821 may store data received from or generated by at least one of other components in a nonvolatile memory.

Each of the WiFi module 823, the BT module 825, the GPS module 827, and the NFC module 828 may include a processor for processing data transmitted/received through a corresponding module. Although the cellular module 821, the WiFi module 823, the BT module 825, the GPS module 827, and the NFC module 828 are shown as separate blocks in FIG. 8, according to an embodiment of the present disclosure, some (for example, at least two) of the cellular module 821, the WiFi module 823, the BT module 825, the GPS module 827, and the NFC module 828 may be included in one integrated chip (IC) or an IC package. For example, at least some (for example, a CP corresponding to the cellular module 821 and a WiFi processor corresponding to the WiFi module 823) of processors respectively corresponding to the cellular module 821, the WiFi module 823, the BT module 825, the GPS module 827, and the NFC module 828 may be implemented with one SoC.

The RF module 829 may be responsible for data transmission, for example, the transmission of an RF signal. Although not shown in the drawings, the RF module 829 may include a transceiver, a power amp module (PAM), a frequency filter, or a low noise amplifier (LNA). Additionally, the RF module 829 may further include components for transmitting/receiving electromagnetic waves on a free space in a wireless communication, for example, conductors or conducting wires. Although the cellular module 821, the WiFi module 823, the BT module 825, the GPS module 827, and the NFC module 828 share one RF module 829 shown in FIG. 8, according to an embodiment of the present disclosure, at least one of the cellular module 821, the WiFi module 823, the BT module 825, the GPS module 827, and the NFC module 828 may perform the transmission of an RF signal through an additional RF module.

The SIM card 824 may be a card including a subscriber identification module and may be inserted into a slot formed at a specific position of an electronic device. The SIM card 824 may include unique identification information (for example, an integrated circuit card identifier (ICCID)) or subscriber information (for example, an international mobile subscriber identity (IMSI)).

The memory 830 may include an internal memory 832 or an external memory 834. The internal memory 832 may include at least one of a volatile memory (for example, dynamic RAM (DRAM), static RAM (SRAM), synchronous dynamic RAM (SDRAM)) and a non-volatile memory (for example, one time programmable ROM (OTPROM), programmable ROM (PROM), erasable and programmable ROM (EPROM), electrically erasable and programmable ROM (EEPROM), mask ROM, flash ROM, NAND flash memory, and NOR flash memory).

According to an embodiment of the present disclosure, the internal memory 832 may be a Solid State Drive (SSD). The external memory 834 may further include flash drive, for example, compact flash (CF), secure digital (SD), micro Micro-SD, Mini-SD, extreme digital (xD), or a memorystick. The external memory 834 may be functionally connected to the electronic device 800 through various interfaces. According to an embodiment of the present disclosure, the electronic device 800 may further include a storage device (or a storage medium) such as a hard drive.

The sensor module 840 measures physical quantities or detects an operating state of the electronic device 800, thereby converting the measured or detected information into electrical signals. The sensor module 840 may include at least one of a gesture sensor 840A, a gyro sensor 840B, a barometric pressure sensor 840C, a magnetic sensor 840D, an acceleration sensor 840E, a grip sensor 840F, a proximity sensor 840G, a color sensor 840H (for example, a red, green, blue (RGB) sensor), a biometric sensor 840I, a temperature/humidity sensor 840J, an illumination sensor 840K, and an ultra violet (UV) sensor 840M. The temperature/humidity sensor 840 may detect a temperature of each unit.

Additionally or alternatively, the sensor module 840 may include an E-nose sensor (not shown), an electromyography (EMG) sensor, an electroencephalogram (EEG) sensor (not shown), an electrocardiogram (ECG) sensor (not shown), an infra red (IR) sensor (not shown), an iris sensor (not shown), or a fingerprint sensor (not shown). The sensor module 840 may further include a control circuit for controlling at least one sensor therein.

The input device 850 may include a touch panel 852, a (digital) pen sensor 854, a key 856, or an ultrasonic input device 858. The touch panel 852 may recognize a touch input through at least one of capacitive, resistive, infrared, or ultrasonic methods, for example. Additionally, the touch panel 852 may further include a control circuit. In the case of the capacitive method, both direct touch and proximity recognition are possible. The touch panel 852 may further include a tactile layer. In this case, the touch panel 852 may provide a tactile response to a user.

The (digital) pen sensor 854 may be implemented through a method similar or identical to that of receiving a user's touch input or an additional sheet for recognition. The key 856 may include a physical button, an optical key, or a keypad, for example. The ultrasonic input device 858, as a device checking data by detecting sound waves through a microphone (for example, a microphone 888) in the electronic device 800, may provide wireless recognition through an input tool generating ultrasonic signals. According to an embodiment of the present disclosure, the electronic device 800 may receive a user input from an external device (for example, a computer or a server) connected to the electronic device 801 through the communication module 820.

The display module 860 may include a display driving module 862, a panel 864, a hologram device 866, or a projector 868. According to an embodiment of the present disclosure, the display driving module 862 may further include a control circuit for controlling the panel 864, the hologram device 866, or the projector 868. The panel 864 may include a liquid-crystal display (LCD) or an active-matrix organic light-emitting diode (AM-OLED). The panel 864 may be implemented to be flexible, transparent, or wearable, for example. The panel 864 and the touch panel 852 may be configured with one module. The hologram 866 may show three-dimensional images in the air by using the interference of light. The projector 868 may display an image by projecting light on a screen. The screen, for example, may be placed inside or outside the electronic device 800.

The interface 870 may include a high-definition multimedia interface (HDMI) 872, a universal serial bus (USB) 874, an optical interface 876, or a D-subminiature (sub) 878 for example. Additionally or alternatively, the interface 870 may include a mobile high-definition link (MHL) interface, a secure Digital (SD) card/multi-media card (MMC) interface, or an infrared data association (IrDA) standard interface.

The audio module 880 may convert sound into electrical signals and convert electrical signals into sounds. The audio module 880 may process sound information inputted/outputted through a speaker 882, a receiver 884, an earphone 886, or a microphone 888.

The camera module 891, as a device for capturing a still image and a video, may include at least one image sensor (for example, a front sensor or a rear sensor), a lens (not shown), an image signal processor (ISP) (not shown), or a flash (not shown) (for example, an LED or a xenon lamp).

The power management module 895 may manage the power of the electronic device 800. The power management module 895 may include at least one regulator for supplying a unit specific voltage to each unit of the electronic device 800. The regulator may output a voltage corresponding to an operating voltage of a unit connected to the regulator by converting the inputted voltage

The power management module 895 may include a charging/discharging module (for example, charger IC), a battery, a battery or fuel gauge, or a power management IC (PMIC).

The charging/discharging module may charge a battery and may prevent overvoltage or overcurrent flow from a charger. According to an embodiment of the present disclosure, the charging/discharging module may include a charger IC for at least one of a wired charging method and a wireless charging method. As the wireless charging method, for example, there is a magnetic resonance method, a magnetic induction method, or an electromagnetic method. An additional circuit for wireless charging, for example, a circuit such as a coil loop, a resonant circuit, or a rectifier circuit, may be added.

The battery supplies power to the electronic device 800 through the power management module 895. The fuel gauge may detect the capacity of a battery. The fuel gauge may notify the remaining battery according to the use of the electronic device 800 to the AP 810.

The battery gauge may measure the remaining amount of the battery 896, or a voltage, current, or temperature thereof during charging. The battery 896 may store or generate electricity and may supply power to the electronic device 800 by using the stored or generated electricity. The battery 896, for example, may include a rechargeable battery or a solar battery.

The PMIC may be built in an IC or SoC semiconductor, for example. A charging method may be classified into a wired method and a wireless method.

The indicator 897 may display a specific state of the electronic device 800 or part thereof (for example, the AP 810), for example, a booting state, a message state, or a charging state. The indicator 897 may include an LED. The motor 898 may convert electrical signals into mechanical vibration. Although not shown in the drawings, the electronic device 800 may include a processing device (for example, a GPU) for mobile TV support. A processing device for mobile TV support may process media data according to the standards such as digital multimedia broadcasting (DMB), digital video broadcasting (DVB), or mediaFLO.

According to various embodiments of the present disclosure, a method and electronic device for controlling a switching regulator may reduce switching noise of high frequency occurring due to on/off switching of a switching regulator by minimizing a change in input current of a power management module. Accordingly, the stability and performance of an electronic device including a switching regulator may be improved.

Each of the above-mentioned components of the electronic device according to various embodiments of the present disclosure may be configured with at least one component and the name of a corresponding component may vary according to the kind of an electronic device. An electronic device according to various embodiments of the present disclosure may include at least one of the above-mentioned components, may not include some of the above-mentioned components, or may further include another component. Additionally, some of components in an electronic device according to various embodiments of the present disclosure are configured as one entity, so that functions of previous corresponding components are performed identically.

The term “module” used in various embodiments of the present disclosure, for example, may mean a unit including a combination of at least one of hardware, software, and firmware. The term “module” and the term “unit”, “logic”, “logical block”, “component”, or “circuit” may be interchangeably used. A “module” may be a minimum unit or part of an integrally configured component. A “module” may be a minimum unit performing at least one function or part thereof. A “module” may be implemented mechanically or electronically. For example, “module” according to various embodiments of the present disclosure may include at least one of an application-specific integrated circuit (ASIC) chip performing certain operations, field-programmable gate arrays (FPGAs), or a programmable-logic device, all of which are known or to be developed in the future.

According to various embodiments of the present disclosure, at least part of a device (for example, modules or functions thereof) or a method (for example, operations) according to this disclosure, for example, as in a form of a programming module, may be implemented using an instruction stored in computer-readable storage media. When at least one processor (for example, the AP 810) executes an instruction, it may perform a function corresponding to the instruction. The non-transitory computer-readable storage media may include the memory 830, for example. At least part of a programming module may be implemented (for example, executed) by the AP 810, for example. At least part of a programming module may include a module, a program, a routine, sets of instructions, or a process to perform at least one function, for example.

The computer-readable storage media may include Magnetic Media such as a hard disk, a floppy disk, and a magnetic tape, Optical Media such as Compact Disc Read Only Memory (CD-ROM) and Digital Versatile Disc (DVD), Magneto-Optical Media such as Floptical Disk, and a hardware device especially configured to store and perform a program instruction (for example, a programming module) such as Read Only Memory (ROM), Random Access Memory (RAM), and flash memory. Additionally, a program instruction may include high-level language code executable by a computer using an interpreter in addition to machine code created by a complier. The hardware device may be configured to operate as at least one software module to perform an operation of various embodiments and vice versa.

A module or a programming module according to various embodiments of the present disclosure may include at least one of the above-mentioned components, may not include some of the above-mentioned components, or may further include another component. Operations performed by a module, a programming module, or other components according to various embodiments of the present disclosure may be executed through a sequential, parallel, repetitive or heuristic method. Additionally, some operations may be executed in a different order or may be omitted. Or, other operations may be added.

Also, embodiments of the present disclosure disclosed in this specification and drawings are provided as specific examples to describe technical content and help understanding and also do not limit the scope of the present disclosure. Accordingly, it should be construed that besides the embodiments listed herein, all modifications or modified forms derived based on the technical ideas of the present disclosure are included in the scope of the present disclosure.

What is claimed is:

1. An electronic device comprising:
a first switching regulator configured to output a predetermined voltage to a first unit of an electronic device through on/off switching corresponding to a control signal received from a switching control unit;
a second switching regulator configured to output a predetermined voltage to a second unit of the electronic device through on/off switching corresponding to a control signal received from the switching control unit; and
a switching control unit configured to determine an off timing of each switching regulator corresponding to an on/off duty ratio of the each switching regulator and control on/off of the each switching regulator in order to turn on the second switching regulator at an off timing of the first switching regulator.

2. The electronic device of claim 1, wherein the switching control unit turns on the second switching regulator by inputting a control signal for turning off the first switching regulator to the second switching regulator.

3. The electronic device of claim 1, wherein the first switching regulator has the same switching frequency as the second switching regulator.

4. The electronic device of claim 1, wherein the switching control unit receives a feedback of an output voltage of the each switching regulator and adjusts the on/off duty ratio on the basis of a change in the output voltage corresponding to load current.

5. The electronic device of claim 1, wherein the switching control unit determines the on/off duty ratio of the each switching regulator on the basis of an input voltage and an output voltage of the each switching regulator.

6. The electronic device of claim 1, wherein the each switching regulator is at least one of a buck converter, a boost converter, and a buck-boost converter.

7. The electronic device of claim 1, wherein the each switching regulator comprises:
a switching driving unit configured to receive the control signal from the switching control unit and turn on/off each of a first switch and a second switch corresponding to the control signal;
the first switch configured to be turned on/off by the switching driving unit; and
the second switch configured to be turned on/off by the switching driving unit,
wherein the each switching regulator performs on/off switching by on/off of the first switch and the second switch.

8. A method of controlling a switching regulator, the method comprising:
turning on a first switching regulator outputting a predetermined voltage of a first unit of an electronic device through on/off switching;
turning on a second switching regulator outputting a predetermined voltage to a second unit of the electronic device through on/off switching simultaneously when turning off the first switching regulator at an off timing of the first switching regulator determined based on an on/off duty ratio of the first switching regulator; and
turning off the second switching regulator at an off timing of the second switching regulator determined based on an on/off duty ratio of the second switching regulator.

9. The method of claim 8, wherein the first switching regulator has the same switching frequency as the second switching regulator.

10. The method of claim 8, further comprising:
receiving a feedback of an output voltage of the first switching regulator and the second switching regulator; and
adjusting an on/off duty ratio of the first switching regulator or the second switching regulator on the basis of a change in the output voltage corresponding to load current.

11. The method of claim 8, wherein the on/off duty ratio of the first switching regulator or the second switching regulator is determined based on an input voltage and an output voltage of a corresponding switching regulator.

12. The method of claim 8, wherein the first switching regulator or the second switching regulator is at least one of a buck converter, a boost converter, and a buck-boost converter.

13. A computer readable recording medium having a program thereon to execute, on a computer, a method of controlling a switching regulator, the method comprising:
turning on a first switching regulator outputting a predetermined voltage of a first unit of an electronic device through on/off switching;
turning on a second switching regulator outputting a predetermined voltage to a second unit of the electronic device through on/off switching simultaneously when turning off the first switching regulator at an off timing of the first switching regulator determined based on an on/off duty ratio of the first switching regulator; and
turning off the second switching regulator at an off timing of the second switching regulator determined based on an on/off duty ratio of the second switching regulator.
